(19) United States
(12) Patent Application Publication
(10) Pub. No.: US 2014/0304511 A1
(43) Pub. Date: Oct. 9, 2014

(54) Sensor module and method for operating a sensor module

(71) Applicants: Matthew LEWIS, Reutlingen (DE); Benjamin GLAS, Stuttgart (DE)

(72) Inventors: Matthew LEWIS, Reutlingen (DE); Benjamin GLAS, Stuttgart (DE)

(73) Assignee: Robert Bosch GmbH, Stuttgart (DE)

(21) Appl. No.: 14/229,194

(22) Filed: Mar. 28, 2014

(30) Foreign Application Priority Data
Apr. 9, 2013 (DE) 10 2013 206 202.8

(51) Int. Cl. H04L 9/32

(52) U.S. Cl. CPC H04L 9/3244
USPC 713/170

(57) ABSTRACT

A sensor module for detecting at least one physical variable. The sensor module is configured to relay measured values, which characterize the at least one physical variable, to an external unit. The sensor module is configured to form a message authentication code and relay it to the external unit. The message authentication code allows the authenticity and integrity of at least one measured value to be checked.

### RELATED APPLICATION INFORMATION

The present application claims priority to and the benefit of German patent application no. 10 2013 206, 202.8, which was filed in Germany on Apr. 9, 2013, the disclosure of which is incorporated herein by reference.

### FIELD OF THE INVENTION

The present invention relates to a sensor module for detecting at least one physical variable, the sensor module being configured to relay measured values which characterize the at least one physical variable to an external unit. Moreover, the present invention relates to a method for operating a sensor module of this type.

### SUMMARY OF THE INVENTION

An object of the present invention is to improve a sensor module and an operating method of the above-mentioned type in such a way that it is possible to reliably recognize manipulations of the measured values of the sensor module.

For the sensor module of the above-mentioned type, this object is achieved according to the present invention in that the sensor module is configured to form a message authentication code and relay it to the external unit, the message authentication code allowing the authenticity and integrity of at least one measured value to be checked.

According to the present invention, it has been found that forming and relaying a message authentication code to a receiver of the measured values advantageously allows the authenticity and integrity of the measured values to be checked. The receiver may carry out a verification process, for example, which corresponds to the formation of the message authentication code in the sensor module according to the present invention, so that a manipulation of the measured values or of the message authentication code may be deduced based on a discrepancy between data thus obtained and the message authentication code which is relayed according to the present invention from the sensor module to the external unit.

In one specific embodiment, it is provided that the sensor module is configured to form the message authentication code as a function of at least one measured value and/or a secret key. The secret key is advantageously stored in the sensor module or a component integrated into same in such a way that it is difficult or impossible to read out the secret key from the outside. A further increase in the protection against manipulation is thus provided. The message authentication code may advantageously be formed as a function of a single measured value or also a plurality of measured values. These measured values may be present in digital form, for example, in the sensor module, and multiple successive measured values may be linked together or concatenated to form larger digital data blocks from which the message authentication code is ascertained.

In another advantageous specific embodiment, it is provided that the message authentication code is a message authentication code (MAC) which is formed with the aid of a cryptographic method, in particular a message authentication code using the advanced encryption standard (AES). Alternatively or additionally, other block ciphers such as DES, Camellia, RC2, 3DES, FEAL, RC6, Blowfish, Serpent, IDEA, Twofish, Skipjack, CAST, MARS, TEA, or XTEA may be used.

In another advantageous specific embodiment, it is provided that a signature is provided instead of the message authentication code (MAC). In this case, the sensor module is thus configured to form a signature and relay it to the external unit, the signature allowing the authenticity and integrity of at least one measured value to be checked.

According to the cryptographic definition, a message authentication code represents information which allows authentication, i.e., checking the authenticity, of a message from which the message authentication code has been derived. In comparison, a signature in the cryptographic sense additionally ensures non-repudiation for the authentication. In simple terms, a signature allows proof not only that a signed message is authentic, but also that it originates from a certain sender (who has signed the message). In contrast, a message authentication code allows proof only of the authenticity, but not of the identification of the sender.

According to the present invention, in the simplest case the sensor module may thus provide a MAC to allow checking of the authenticity of the measured values. Alternatively or additionally, the sensor module may provide a signature which also allows identification of the sensor module.

The term “signature” may be used in the following description. However, it is pointed out that all exemplary embodiments may include a message authentication code instead of a signature.

In another advantageous specific embodiment, it is provided that a sensor security module which is integrated into the sensor module is provided which is configured for forming the signature or the MAC. This has the advantage that the functions or the corresponding functionality necessary for forming the signature or the MAC may be concentrated in the sensor security module, so that existing sensor modules may be easily supplemented with the sensor security module in order to obtain a sensor module according to the present invention.

A further advantage is that security-relevant functions such as the signature formation may be fully integrated into the sensor security module and optionally further protected against attacks, for example reading out of data, etc., without the need for providing remaining components of the sensor module with the same security measures. Consequently, the security measures advantageously do not impair security-relevant functionality of the sensor module. As a result of one specific embodiment, the sensor module may even process measured values and relay them to the external unit when the sensor security module is no longer functioning properly. In this case, for example, supplementing the signature is to be dispensed with, although the measured values per se may still be relayed.

In another advantageous specific embodiment, it is provided that the sensor module has a signal processing unit for processing the measured values, as well as an interface unit for relaying the measured values and/or signature to the external unit, and that the sensor security module is in data connection with the signal processing unit and/or the interface unit. The signal processing unit may be, for example, a digital signal processor or a microcontroller or the like, and the interface unit may be, for example, a communication interface, which may be bidirectional, via which the sensor module is connectable to a bus system or to an external control unit, for example a control unit of a motor vehicle.

When the sensor security module is in data connection with the data processing unit, the sensor security module may directly access the measured values present in the data processing unit, for example to combine the measured values into larger data blocks which are supplied to the signature formation. A data connection between the sensor security module and the interface unit also advantageously allows influencing of the communication on the part of the sensor security module via the interface unit. For example, signatures or MACs formed in this way by the sensor security module may be directly supplied to the interface unit for relaying to the external unit.

In another advantageous specific embodiment, it is provided that the sensor security module is configured to combine a plurality of measured values, present in digital form, into a data block, and to process the data block to obtain the MAC or the signature. The formation of the MAC or the signature may take place according to the AES standard, for example. In addition to data blocks and measured values, the signature formation may also be supplied with additional values, in particular values which represent operating variables, or values of counters.

As the result of one specific embodiment, the formation of the MAC or the signature may take place according to the so-called “CMAC” standard. Details in this regard may be obtained from the Internet site http://csrc.nist.gov/publications/nistpubs/800-38B/SP_{—}800-38B.pdf.

In another advantageous specific embodiment, it is provided that the sensor module or the sensor security module is configured to carry out an AES encryption, and that the sensor security module is not configured to carry out an AES decryption. In this specific embodiment, it is particularly advantageous that only one AES encryption function is implemented in the sensor module, and the other functional components for implementing an AES decryption may advantageously be dispensed with, which advantageously reduces the complexity of the sensor module according to the present invention.

Likewise, an encrypted communication may be carried out in both directions between the external unit and the sensor module according to the present invention via the interface unit, for example. For example, the external unit (the control unit, for example) may also send encrypted data to the sensor module according to the present invention via the interface unit, the sensor module being able to decrypt the encrypted data despite the lack of an AES decryption unit. For this purpose, as the encryption method it is advantageously provided that the control unit processes the data to be encrypted in the course of an AES decryption process, and the data thus obtained are transmitted to the sensor module according to the present invention. After an AES encryption in the sensor module, the data transmitted by the control unit are present in the sensor module in plaintext form, without the sensor module according to the present invention requiring an AES decryption unit for this purpose. In other words, this specific embodiment of the present invention provides that the sensor module carries out an AES encryption for decrypting encrypted data; i.e., the sensor module is configured to decrypt encrypted data by subjecting the encrypted data to an AES encryption.

One application scenario using the above-described specific embodiment may be as follows, for example:
1. The external control unit and the sensor module are initialized (power-up).
2. The external control unit generates a session key and encrypts the session key with a master key of the sensor module, using the AES decryption algorithm.
3. The external control unit sends the session key encrypted in this manner to the sensor module.
4. The sensor module receives the session key encrypted in this manner and decrypts it, using the AES encryption algorithm.
5. The sensor module generates MACs using the decrypted session key, for example using the CMAC standard.

In this specific embodiment, the customary sequence of AES encryption and AES decryption is advantageously reversed; i.e., encryption is carried out using the AES decryption, and decryption is carried out using the AES encryption, so that advantageously only the functionality of the AES encryption, but not of the AES decryption, is necessary in the sensor module. The hardware of the sensor module may thus be less complex and therefore less expensive.

In one specific embodiment, the sensor module is thus advantageously configured to decrypt encrypted data, using the AES encryption. This is advantageously possible in particular when the encryption is carried out using the AES decryption.

In another advantageous specific embodiment, the following application scenario results:
1. The external control unit and the sensor module are initialized (power-up).
2. The external control unit generates a random bit sequence having a length of 128 bits, for example, using a random generator (a true random number generator (TRNG), for example), and sends this random bit sequence to the sensor module.
3. The external control unit forms a session key by AES encryption of the random bit sequence, using the master key.
4. The sensor module similarly forms the session key by AES encryption of the random bit sequence, using the master key.
5. The sensor module generates MACs using the session key, for example using the CMAC standard.

A particularly low latency advantageously results in this application scenario.

In another advantageous specific embodiment in which, for example, only unidirectional communication from the sensor module to the external control unit, and not the other way around, is possible, the following application scenario results:
1. The external control unit and the sensor module are initialized (power-up).
2. The sensor module generates MACs using the master key, which is known in the sensor module as well as in the external control unit, for example using the CMAC standard.
3. The external control unit checks the MACs, using the master key.

Another approach to achieving the object of the present invention is provided by the method according to Patent claim 9. Further advantageous specific embodiments are the subject matter of the subclaims.

Further features, possible applications, and advantages of the present invention result from the following description of exemplary embodiments of the present invention which are illustrated in the figures of the drawing. All described or illustrated features, alone or in any arbitrary combination, constitute the subject matter of the present invention, regardless of their recapitulation in the patent claims or their back-reference, and regardless of their wording or illustration in the description or drawing, respectively.

### BRIEF DESCRIPTION OF THE DRAWINGS

FIG. 1 schematically shows a block diagram of one specific embodiment of the sensor module according to the present invention.

FIG. 2 schematically shows a block diagram of another specific embodiment of the sensor module according to the present invention.

FIG. 3 schematically shows a block diagram of a sensor security module of the sensor module according to FIG. 2.

FIG. 4 shows a simplified flow chart of one specific embodiment of the method according to the present invention.

### DETAILED DESCRIPTION

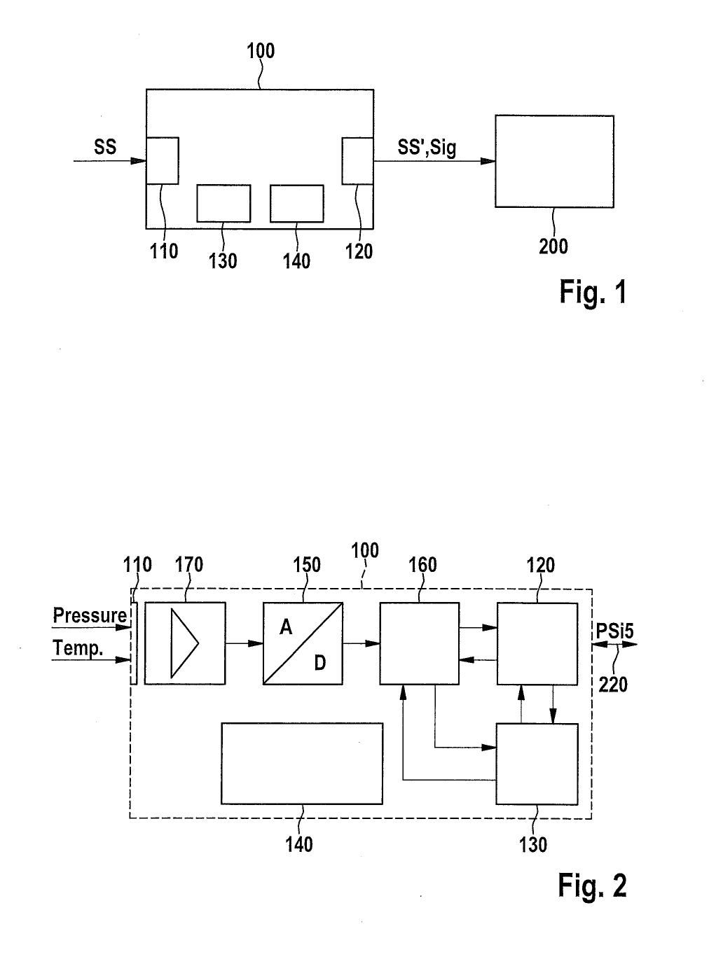

FIG. 1 schematically shows a sensor module 100 which is used, for example, in the automotive field for detecting at least one physical variable (pressure, temperature, etc.). For this purpose, sensor module 100 has a first interface unit 110 via which a sensor signal SS may be supplied to sensor module 100. Sensor signal SS may be provided with the aid of an external sensor, for example (not shown). In particular, the sensor signal may be an electrical variable, such as a voltage or a current, which is already delivered by the sensor to sensor module 100 as a function of a detected physical variable. Alternatively, an appropriate sensor may also be directly integrated into sensor module 100, in particular into interface 110.

Sensor module 100 processes sensor signal SS. For example, provided that sensor signal SS is present as an analog signal such as an analog voltage, sensor module 100 carries out an analog-digital conversion, so that digital measured values SS′ which represent the physical variable or sensor signal SS are obtained. These measured values SS′ may be relayed to an external component 200 via a second interface unit 120. External component 200 may be, for example, a control unit of a motor vehicle.

In addition to interface units 110, 120, sensor module 100 also has a control unit 140, which may be a finite state machine, for example, and which may be implemented, for example, in a microcontroller or in an application-specific integrated circuit (ASIC) or the like. Control unit 140 controls, for example, the detection of sensor signal SS at interface unit 110 as well as the relaying of measured values SS′ derived therefrom to second interface unit 120 or external unit 200.

According to the present invention, sensor module 100 is configured to form a message authentication code (MAC) Sig and relay it to external unit 200. MAC Sig may, for example, be transmitted in addition to measured values SS′ to external unit 200 via second interface unit 120. MAC Sig advantageously allows control unit 200 to check the authenticity and integrity of measured values SS′.

In another advantageous specific embodiment, it is provided that a signature is provided instead of the MAC. In this case, sensor module 100 is thus configured to form a signature and relay it to the external unit, the signature allowing the authenticity and integrity of at least one measured value to be checked. In addition, the signature allows the identity of sensor module 100 to be checked.

The term “signature” may be used in the following description. However, it is pointed out that all exemplary embodiments may include a message authentication code instead of a signature. This means that the descriptions involving the feature, provided below with the reference character “Sig,” similarly also relate to MACs.

As the result of one specific embodiment, the functionality for forming signature Sig may be integrated into control unit 140. According to one alternative specific embodiment, however, the functionality for forming signature Sig is situated in a separate sensor security module 130.

Sensor security module 130 may once again be configured as an ASIC or microcontroller or the like, and may be integrated into sensor module 100.

In one particular specific embodiment, sensor module 100 or sensor security module 130 forms signature Sig as a function of at least one measured value SS′ and/or a secret key.

For this purpose, the secret key may be stored in sensor module 100, in particular in sensor security module 130, so that the secret key is available for forming the signature.

In one specific embodiment, signature Sig is a message authentication code that is formed with the aid of a cryptographic method, in particular a message authentication code that is formed using the advanced encryption standard (AES), thus providing particularly high reliability with respect to manipulation.

For example, sensor security module 130 may form signature Sig as a function of one or multiple measured values SS′ and the secret key, and may relay the signature together with the corresponding measured values SS′ to external unit 200.

After receiving this data SS′, Sig, external unit 200 in turn may form a signature (the method is similar to that for the functionality of sensor security module 130), and the signature formed in external unit 200 as a function of sensor data SS′ and a likewise secret key may be compared to signature Sig which is transmitted to external unit 200 by sensor module 100 according to the present invention. If the signatures match, it may be deduced that no manipulation or impairment of the integrity of the data sent by sensor module 100 is present. If the signature formed by external unit 200 differs from signature Sig which is sent by sensor module 100, it may be deduced that a manipulation of measured values SS′ or of signature Sig is possibly present. External unit 200 may have the same secret key as sensor module 100 or sensor security module 130.

Accordingly, sensor module 100 according to the present invention advantageously allows checking of the authenticity and integrity of measured values SS′ which are supplied to external unit 200 for further processing.

For example, sensor module 100 may be provided for detecting a so-called rail pressure, i.e., a pressure in a pressure accumulator (rail or common rail) of a fuel system of a motor vehicle. In addition to the rail pressure, sensor module 100 may also detect a temperature (see specific embodiment 100 according to FIG. 2).

In the configuration depicted in FIG. 2, sensor module 100 detects the rail pressure “Pressure” as well as a temperature “Temp” via first interface unit 110, using sensors (not illustrated) which provide their sensor signals to interface unit 110.

As described in greater detail below, these data are processed and relayed in the form of measured values SS′ to external unit 200 (FIG. 1). To make attempts to manipulate measured values SS′ recognizable, sensor module 100 according to FIG. 2 uses the function, described above with reference to FIG. 1, for forming a signature, so that external unit 200 may check the authenticity and integrity of measured values SS′. It is thus possible for control unit 200 to establish whether measured values SS′ have been impermissibly modified, for example within the scope of so-called tuning measures in which deliberate falsification of measured values SS′ delivered to control unit 200 by sensor module 100 takes place.

The function of sensor module 100 according to FIG. 2 is described in greater detail below.

The detected pressure and temperature values are relayed by first interface unit 110 to an amplifier 170, which appropriately amplifies the detected values or signals. The amplified signals are supplied to an analog-digital converter 150 which converts analog signals into digital signals. Accordingly, the detected variables rail pressure and temperature are present as digital data words at the output of AD converter 150. These data are supplied to signal processing unit 160, which in the present case is configured as a digital signal processor (DSP), for further processing. Digital signal processor 160 in turn relays the processed data to second interface unit 120, which relays the data in the form of measured values SS′ to external unit 200 (FIG. 1) via a data interface 220, which in the present case is configured as a peripheral sensor interface 5 (PSI5).

The operation of sensor module 100 and its components is controlled by control unit 140.

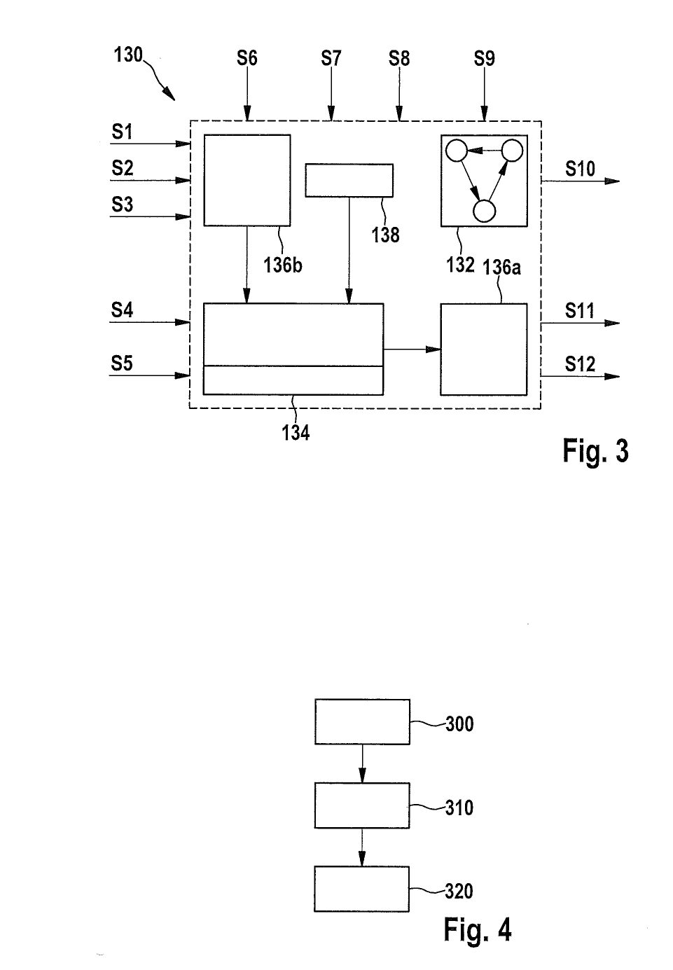

For forming the signature in the above-described manner, a sensor security module 130 is provided in sensor module 100 which is in data connection with digital signal processor 160 and also with second interface unit 120. FIG. 3 schematically shows a block diagram of sensor security module 130 according to the present invention.

Sensor security module 130 has a control unit 132 which controls the processes of sensor security module 130 and which is configured as a finite state machine, for example.

In addition, sensor security module 130 has a cryptography unit 134 which is configured for carrying out a cryptographic method. As the result of one specific embodiment, the cryptographic method is advantageously used for forming signature Sig (FIG. 1) as a function of one or multiple measured values SS′ and a secret key.

Cryptography unit 134 particularly may operate according to the AES cryptography standard. In particular, it may be sufficient for cryptography unit 134 to be configured to carry out only AES-conformant encryption. A functionality for the AES-conformant decryption does not have to be contained in cryptography unit 134, which advantageously allows a less complicated structure of cryptography unit 134, in particular using a smaller chip surface area than with full AES implementations.

Sensor security module 130 also has an output buffer 136a which may temporarily store signatures formed by cryptography unit 134 before they are relayed, for example to second interface unit 120 of sensor module 100 according to FIG. 2. An input buffer 136b may likewise be provided in sensor security module 130, whose function is explained in greater detail below. Buffers 136a, 136b may be configured, for example, as memory registers of a microcontroller which implements the functionality of sensor security module 130.

In addition, sensor security module 130 has a counter 138, whose function is likewise explained below.

In one specific embodiment, multiple signals s1, s2, . . . , s9 are supplied to sensor security module 130, and sensor security module 130 outputs multiple signals s10, s11, s12. The meanings of the signals are explained in greater detail below.

Signal s1 supplied to sensor security module 130 represents a global clock signal, which may be provided, for example, by control unit 140 of sensor module 100 (FIG. 2). Signal s2 (FIG. 3) represents a reset signal which may be configured as “active high,” for example, and which is used to reset sensor security module 130, i.e., to initialize control system 132, for example. For this purpose, for example, a signal having the logic level “high” is applied to sensor security module 130 at the appropriate input for reset signal s2.

Signal s3 may advantageously be used to indicate to sensor security module 130 that the present signature (or MAC) has been sent via the PSI5 bus or at least has been read out from sensor security module 130, and that, for example, the next signature or MAC may be made available on output signal S11.

Signals s4, s5 may be used to signal to sensor security module 130 the transmission of a module-specific secret key, or to effect the transmission. For example, the secret key may be stored in a one-time programmable (OTP) memory of sensor module 100 and transmitted to sensor security module 130 via signals s4, s5. In this regard, the secret key may be transmitted directly via signal s4, while signal s5 is used to signal to security module 130 the imminent transmission of the secret key.

Signals s6, s7 may be used to supply sensor security module 130 with a session-dependent key which, similarly as for the secret key, may likewise be used for forming signature Sig. A varying key may thus advantageously be used for each new encryption process, i.e., the formation of a new signature Sig, by associating a so-called individual “session key” with each process. The transmission of the session-dependent key may take place similarly as for signals s4, s5; i.e., with the aid of signal s7 the imminent transmission of the session-dependent key via signal s6 is indicated to sensor security module 130. The session-dependent key may be supplied to sensor security module 130, for example, by external unit via interface 120 (FIG. 1), or may also be provided by sensor module 100, which has agreed on the session-dependent key with external unit 200.

Measured values SS′, for example measured pressure values or measured temperature values or the like, may be supplied to sensor security module 130 via signals s8, s9 for purposes of the signature formation, for example via digital signal processor 160 of sensor module 100 (FIG. 2).

Sensor security module 130 may signal via output signal s10 to an external unit, for example control unit 140, that the sensor security module is at full capacity utilization, for example for forming a signature or the like.

The signatures generated by sensor security module 130 may be relayed via further output signals output signals s11, s12 to second interface unit 120 (FIG. 2), for example, where they may be integrated into the communication data stream to external unit 200.

Memory 136a may be configured according to the first in, first out (FIFO) principle, for example, and to temporarily store multiple signatures generated by sensor security module 130 before they are relayed to second interface unit 120.

Similarly, second memory 136b may likewise be configured as a FIFO memory, and may temporarily store one or multiple incoming measured pressure values for future processing by cryptography unit 134.

FIG. 4 shows a simplified flow chart of one specific embodiment of the method according to the present invention. At least one physical variable is detected by sensor module 100, for example by first interface unit 110, in a first step 300.

Sensor module 100 or sensor security module 130 integrated into same forms a signature in a second step 310 as a function of measured values which have been ascertained from the detected physical variables, and also as a function of at least one secret key which may be stored, for example, in cryptography unit 134 (FIG. 3).

Sensor module 100 sends signature Sig (FIG. 1), previously formed in step 310, to external unit 200 via second interface unit 120 in subsequent step 320 (FIG. 4).

Upon receiving signature Sig, external unit 200 may complete the signature formation using likewise transmitted measured values SS′, and, based on a comparison of the signature which is locally formed in external unit 200 with signature Sig which is transmitted by sensor module 100 to external unit 200, may establish whether signature Sig or measured values SS′ have been manipulated.

Thus, tuning measures, which are based on a falsification of measured values SS′ during their transmission from module 100 to control unit 200, are not prevented, but are recognizable in control unit 200 due to the fact that, in the event of manipulation, measured values SS′ received by the control unit do not match signature Sig which is provided by sensor module 100.

As an alternative or in addition to the signature formation, sensor module 100 due to its sensor security module 130 may also provide encryption of measured values SS′ so that they do not have to be transmitted in plaintext form via interface 220 (FIG. 2). Tuning measures may thus be prevented or made considerably more difficult.

In another specific embodiment, sensor security module 130 (FIG. 3) combines a plurality of measured values SS′, which are present in digital form and listed in chronological order, for example, into a data block, and the entire data block is encrypted to obtain signature Sig. In this way, the length of the data words representing measured values SS′ may advantageously be adapted to a data width of 128 bits or 256 bits, for example, which is favorable for the encryption or signature formation.

Sensor module 100 according to the present invention advantageously allows recognition of manipulation of measured values SS′ or signature Sig in a control unit 200 which receives measured values SS′ or signature Sig. For example, tuning measures or manipulations of the rail pressure sensor, which supplies measured values SS′ on which the signature formation is based, may be recognized in this way.

If sensor module 100 uses measured values SS′ for the signature formation, but further relays measured values SS′ themselves to external unit 200 as plaintext, i.e., unencrypted, the use of tuning measures which, for example, modify measured values SS′ during their transmission between components 100, 200, is still possible. However, due to signature Sig, which is likewise sent to external unit 200, the external unit may detect the modification of measured values SS′.

Due to providing sensor module 100 according to the present invention, the option is also advantageously provided for establishing on the part of control unit 200 whether an original sensor module is used which accordingly controls the signature formation according to the present invention and which has the corresponding secret key. In addition, sensor module 100 according to the present invention advantageously allows authentication and/or verification of the measured values.

Sensor module 100 according to the present invention is not limited to the processing of rail pressure values or temperature values. Rather, the principle according to the present invention may also be used for detecting other physical variables, in particular in a motor vehicle. In particular, sensor module 100 according to the present invention may be completely integrated into existing sensor modules or sensor components. For this purpose, all components of sensor module 100 are advantageously configured in the form of an application-specific integrated circuit (ASIC) or a field programmable gate array (FPGA) or the like.

A 32 bit-based implementation of the AES encryption which is particularly efficient and which may be achieved using the smallest possible chip surface area is particularly advantageously used in cryptography unit 134 (FIG. 3).

Measures for hardening sensor module 100 or sensor security module 130 against so-called side channel attacks or general attacks based on the differential power analysis (DPA) technique may likewise be provided and taken into account in the implementation of sensor module 100.

As a whole, sensor module 100 according to the present invention allows the reliable checking of measured values SS′ for authenticity and integrity at a relatively low additional cost for implementing the functionality according to the present invention.

In one specific embodiment in which as physical variables the rail pressure and the temperature of an internal combustion engine or of the fuel are detected by measurement, it may also be provided that continued (pre)processing of the measured values takes place in digital signal processor 160 (FIG. 2). For example, a temperature dependency of the rail pressure may be taken into account, and digital signal processor 160 may already provide rail pressure values which are compensated for temperature.

In another advantageous specific embodiment, it is provided that sensor security module 130 (FIG. 2) is configured to ascertain which of the data to be transmitted via interface 220 are to be protected by a signature or encrypted.

In another advantageous specific embodiment, it is provided that a plurality of measured values which are present in digital form are combined into a data block, and that for a data block of this type a signature is formed by sensor security module 130. For example, in each case 100 measured values SS′ may be combined into a data word or a bit sequence, and this bit sequence undergoes the signature formation.

For example, digital signal processor 160 may additionally ascertain mean values of corresponding measured values SS′ or extreme values or the like. These values may likewise be transmitted to external unit 200 (FIG. 1). In addition, these further values which are derived from measured values SS′ may be the basis for the signature formation.

In one particular specific embodiment, sensor security module 130 is configured in such a way that a secret key which is necessary for the AES encryption is programmable one time in sensor security module 130 or in a corresponding memory. It may be that this key cannot be read out by units which are external to sensor module 100, for example via interface 120. Accordingly, it is advantageous when only sensor security module 130 is able to access the secret key for carrying out the AES encryption. The secret key may be stored in a so-called one-time programmable (OTP) memory.

The value of the secret key may be formed, for example, as a function of operating parameters of a manufacturing process for sensor security module 130 or the like.

Alternatively, it is possible to program the secret key in sensor security module 130, for example at the end of a manufacturing process for sensor module 100.

Additional secret keys, so-called session keys, which may be transmitted from external unit 200 to sensor module 100, for example, may likewise be used for the signature formation or encryption to allow a further increase in security at the session level. For example, control unit 200 may send a new session key to sensor module 100 via communication interfaces 220 or 120. Control unit 140 supplies this new session key to sensor security module 130 (for example, via signals s6, s7 according to FIG. 3), or sensor security module 130 reads out this new key directly from interface unit 120 or from digital signal processor 160. Sensor security module 130 may then use the new session key for processes of the signature formation or AES encryption.

In another specific embodiment, external unit 200 sends a session key to sensor module 100 via the PSI5 bus. The session key may be encrypted, for example, and sensor module 100 or sensor security module 130 uses a master key which is known to both components 130, 200 in order to decrypt the session key. The decrypted session key may then be used in sensor security module 130 in order to generate MACs and/or signatures.

As described above, decryption (according to the AES standard, for example) may be used in external unit 200 for encrypting the master key, and the decryption is carried out in module 130 via an AES encryption. In this variant, module 130 advantageously requires only AES encryption functionality, which is computationally less complex than a corresponding AES decryption.

Alternatively, a random number (a 128-bit random string, for example) may be generated in external unit 200 and sent to module 130. Both units 130, 200 may then encrypt the random number, according to AES, for example, thus obtaining a shared session key.

Sensor module 100 or sensor security module 130 may be configured in such a way that only sensor security module 130 “knows” the session key in its unencrypted form, thus further increasing the security of the system.

In another specific embodiment, it is provided that only one master key is used to generate MACs. Thus, no session key is required.

As an example, measured values SS′ output by digital signal processor 160 may be digital words having a width of 12 bits. Other data widths are likewise conceivable.

In another advantageous specific embodiment, sensor security module 130 collects a plurality of measured values SS′ in chronological order, for example, and forms a so-called message authentication code for a plurality of measured values SS′ with the aid of cryptography unit 134.

For example, a message authentication code having a length of 72 bits, for example, may be formed from 189 measured pressure values SS′.

In another advantageous specific embodiment, a value of a counter 138 (FIG. 3) may also be taken into account in forming the signature or the encryption, thus making so-called replay attacks more difficult. As the result of one advantageous specific embodiment, the message authentication code formed by cryptography unit 134 (FIG. 3) may be formed using the AES encryption method. For example, a first plurality of measured values SS′ is combined into an input data word having a width of 128 bits, for example, a length adjustment being possible, if necessary, by appending null bits (padding). The input data word subsequently undergoes an AES encryption by cryptography unit 134, using the secret key. The input data word encrypted in this way according to AES may advantageously be linked to further input data words, likewise having a bit width of 128 bits, and once again undergoes an AES encryption, and so forth. After a sufficient number of linkages or AES encryption steps, the data word obtained in this way may be used as the message authentication code. Portions of the obtained data word may likewise be used as the message authentication code. For example, for an output data word, having a length of 128 bits, which originates from multistep AES encryption and linkage, a message authentication code having a length of 72 bits may be obtained.

Also in the above-described procedure, once again a counter value of counter 138 or of a communication sequence via interface 220 (FIG. 2) or the like may be included in the linkage or encryption in order to make replay attacks more difficult.

In another advantageous specific embodiment, a secret key for the signature formation or carrying out the AES encryption method in cryptography unit 134 by an external unit 200 may be loaded into sensor module 100. The secret key particularly advantageously already undergoes an AES decryption in external unit 200, as the result of which the new secret key is transmittable in an encrypted form to sensor module 100. Sensor module 100 or sensor security module 130, using its cryptography unit 134, may use an AES encryption on the piece of data received in this way which has already been decrypted by AES and which represents the new secret key. This AES encryption in cryptography unit 134 restores the initial state, i.e., the plaintext of the new secret key which external unit 200 has provided to it. In this way an AES-encrypted transmission of a new secret key from external units 200 to sensor module 100 may take place without the need for sensor module 100 or sensor security module 130 to have a functionality for carrying out an AES decryption. A particularly compact configuration is thus possible which manages with a relatively small chip surface area. In particular, a functionality for implementing an AES-conformant decryption may be completely dispensed with.

As the result of another specific embodiment, cryptography unit 134 particularly advantageously has a highly optimized variant of an AES computation core, so that installation space and computing time may be saved.

One measure for increasing the power of the AES computation core is to combine the carrying out of multiple SubByte function steps according to the AES algorithm. As is known, the SubByte function step of the AES standard is carried out on individual bytes of the state matrix of the AES cryptosystem. According to the present invention, it is proposed to provide a 32 bit-wide implementation by combining and simultaneously carrying out four function steps of the SubByte type. This means that according to the present invention, the nonlinear substitution operation, which is implemented by the “SBOX” unit according to the AES standard, may be parallelized by a factor of four, for example, to allow an efficient implementation on 32-bit signal processors or microcontrollers. At the same time, parallelizing the SBOX functionality advantageously also results in an increase in security against DPA attacks.

In addition, cryptography unit 134 may be configured in such a way that it may operate with input data words and output data words having different data widths, for example 32 bits and 128 bits, as the result of which efficiency of the operation may be further increased.

In another advantageous specific embodiment, it is provided that the secret key for the signature formation or AES encryption cannot be read out from sensor module 100 or from sensor security module 130, for example via an internal diagnostic interface (scan chain) which is used within the scope of semiconductor manufacture. It may advantageously be provided, for example, that as soon as a readout instruction is received via the diagnostic interface, a plurality of the memory registers in sensor module 100 or in its control unit 140 or in digital signal processor 160 or in sensor security module 130 is cleared. In this way, cryptographically relevant information of sensor module 100 is protected from being read out.

The secret key for the signature formation or AES encryption may be stored in a flash memory or in an OTP memory. It may be that only sensor security module 130 may access the secret key stored in this way, in order to be able to carry out the signature formation or the AES encryption algorithm with the aid of cryptography unit 134.

In another specific embodiment, it is provided that digital signal processor 160 or interface unit 120, for example, has no access to the secret key.

If units 140, 130, 160, 120 are functionally integrated, for example on a shared ASIC, appropriate protective mechanisms must be provided which prevent the components from mutually accessing memory areas used by other components, in order to prevent the secret key from being read out by a component other than sensor security module 130.

To further increase the security of sensor module 100 according to the present invention with respect to differential power analysis (DPA) attacks, in another specific embodiment it is proposed that sensor module 100 is configured in such a way that individual components 120, 140, 170, 160, 150 cannot be separately disconnected from an operating power supply or shut down. It would thus be possible in principle to carry out a targeted DPA attack on cryptography unit 134 of sensor security module 130, since the energy signature of the latter upon shutdown of the other components would then no longer be superimposed with the signatures of the other components.

Read access to the secret key for the AES encryption, for example when cryptography unit 134 reads in the key for the signature formation, should be configured in such a way that it includes maximum block sizes, which may be the entire key length of approximately 128 bits, for example, all at once. If the OTP memory containing the secret key has a word width of less than 128 bits, at least other components of sensor module 100 should also be active, in the sense of generating a nonvanishing energy signature, during the read access, in order to at least partially mask or conceal the readout process of the secret key for the AES encryption. It is also possible to integrate one or multiple noise sources on sensor module 100 or sensor security module 130, or other units which may generate (pseudo) random information, in order to conceal an energy signature of sensor module 100, in particular during the readout of the secret key for the AES encryption from the OTP memory.

As the result of another advantageous specific embodiment, a further limitation of possible attacks on cryptography unit 134 may be achieved by deactivating sensor security module 130 together with its cryptography unit 134 (for example, by disconnection from a power supply source) as soon as certain operating variables of sensor module 100 allow a conclusion to be drawn that sensor module 100 is not in normal operation, but, rather, is in test operation, which could possibly represent a DPA attack on cryptography module 134. For example, a bus clock of units 130, 140, 120 and/or a supply voltage and/or an operating temperature and/or a value range of detected measured values SS′ may be tested as to whether predefinable normal operating parameter ranges are maintained. If this is not the case, control unit 140 may deactivate sensor security module 130 in a targeted manner in order to thwart attacks.

In other words, sensor security module 130 may be deactivated as soon as an attack is recognized, or as soon as sensor module 100 is transferred into a diagnostic or calibration mode, i.e., in which normal operation does not take place for detecting measured values. Multifaceted attacks on sensor security module 130 are thus advantageously made difficult or impossible.

The present invention advantageously allows recognition and/or prevention of the manipulation of sensor data or measured values which are sent from sensor module 100 to an external unit 200. In addition, it is advantageous that no delays or significant latencies are caused by the MAC or signature formation or encryption according to the present invention. In addition, the MAC or signature length may be kept very small, for example 72 bits or less, so that no appreciable additional data volume is to be transmitted via interface 220.

In another specific embodiment, the sensor, for example a pressure sensor or the like, and module 100 or module 130 may be situated on the same semiconductor chip, implemented in an ASIC, for example.

What is claimed is:

1. A sensor module for detecting at least one physical variable, comprising:
a relay arrangement to relay measured values which characterize the at least one physical variable to an external unit;
a code arrangement to form a message authentication code and relay it to the external unit, wherein the message authentication code allows an authenticity and integrity of at least one measured value to be checked.

2. The sensor module of claim 1, wherein the sensor module is configured to form the message authentication code as a function of at least one of at least one measured value and a secret key.

3. The sensor module of claim 1, wherein the message authentication code is formed with the aid of a cryptographic method, using the advanced encryption standard (AES).

4. The sensor module of claim 1, further comprising:
a sensor security module integrated into the sensor module and being configured for forming the message authentication code.

5. The sensor module of claim 4, wherein the sensor module includes a signal processing unit for processing the measured values, as well as an interface unit for relaying the measured values and/or the message authentication code to the external unit, and wherein the sensor security module is in data connection with the signal processing unit and/or the interface unit.

6. The sensor module of claim 4, wherein the sensor security module is configured to combine a plurality of measured values which are present in digital form into a data block, and to encrypt the data block to obtain the message authentication code.

7. The sensor module of claim 1, wherein the sensor module or the sensor security module is configured to carry out an AES encryption, and wherein the sensor security module is not configured to carry out an AES decryption.

8. The sensor module of claim 1, wherein the sensor module or the sensor security module is configured to decrypt encrypted data, using an AES encryption.

9. A method for operating a sensor module for detecting at least one physical variable, the method comprising:
forming, using the sensor module, a message authentication code, wherein the sensor module is configured to relay measured values, which characterize the at least one physical variable, to an external unit;
relaying it to the external unit; and
checking an authenticity and integrity of at least one measured value, wherein the message authentication code allows the authenticity and integrity of at least one measured value to be checked.

10. The method of claim 9, wherein the message authentication code is formed with the aid of a cryptographic method, using the advanced encryption standard (AES).

11. The method of claim 9, wherein a sensor security module combines a plurality of measured values which are present in digital form into a data block, and encrypts the data block to obtain the message authentication code.

12. The method of claim 9, wherein a value of a counter is taken into account in forming the message authentication code.

13. The method of claim 9, wherein a session-dependent key is taken into account in forming the message authentication code.
